(19) United States
(12) Patent Application Publication
(10) Pub. No.: US 2012/0003910 A1
(43) Pub. Date: Jan. 5, 2012

(54) HVAC SYSTEM FOR VEHICLES WITH BATTERY COOLING

(75) Inventor: Gerald Richter, Aachen (DE)

(73) Assignee: VISTEON GLOBAL TECHNOLOGIES, INC., Van Buren TWP., MI (US)

(21) Appl. No.: 13/169,447

(22) Filed: Jun. 27, 2011

(30) Foreign Application Priority Data
Jul. 2, 2010 (DE) 102010030892.7

(51) Int. Cl. B60H 1/24; H01M 10/50

(52) U.S. Cl. 454/141

(57) ABSTRACT

An HVAC system for a vehicle including a battery casing having a battery disposed therein, an air conditioning device in fluid communication with a passenger compartment of the vehicle, and an air distribution system including an outflow channel and a return channel. The outflow channel fluidly connects the battery casing with an ambience of the vehicle and the return channel fluidly connects the battery casing with the passenger compartment. The air conditioning device includes an ambient air channel for receiving an air mass flow from the vehicle ambience, a recirculating air channel for receiving an air mass flow from the passenger compartment, and a battery cooling channel to fluidly connect the air conditioning device and the battery casing. The conditioned air mass flow from the air conditioning device is directed into the passenger compartment and/or the battery casing to maintain a desired temperature of the passenger compartment and/or the battery.

### CROSS-REFERENCE TO RELATED APPLICATION

The present application claims priority to German Patent Application No. 10 2010 030 892.7 filed Jul. 2, 2010, the entire disclosure of which is hereby incorporated herein by reference.

### FIELD OF THE INVENTION

The invention relates to a heating, ventilating, and air-conditioning (HVAC) system for vehicles with battery cooling, especially for hybrid or electric vehicles, with the HVAC system also provided for conditioning the battery.

### BACKGROUND OF THE INVENTION

In prior art, various systems for cooling batteries in electric or hybrid vehicles are known. Refrigerant-cooled or coolant-cooled systems are used. In the coolant-cooled systems, apart from glycol as coolant, air is used for cooling the batteries, with ambient air being passed through the batteries, partly in an unconditioned state. On a hot summer day the outside air temperature, however, can reach or even exceed values of 40° C. so that no cooling is possible using the unconditioned ambient or outside air. Such outside conditions often require disadvantageously reducing the battery output in order to minimize heat produced during operation.

Moreover, the high-capacity batteries used in electric or hybrid vehicles, such as Li-ion batteries, have a narrow optimum temperature range for discharging and charging. Any increase in operating temperature results in a very high thermal loading of the battery cells and electronic components. Operation outside the optimum temperature range significantly reduces the life of the battery. Therefore, it is critical to remove the heat produced during operation. Further, it is required that the temperature range over the single battery cells be small.

In order to ensure the very narrow optimum temperature range for the battery while operated at maximum output, the air cooling therefore requires appropriately conditioning the cooling air.

From prior art, it is known to use a conventional HVAC system provided with an additional outlet for cooling the air delivered to the battery during operation or battery charging. The system blows the cooling air through a channel system into the battery casing, passes it around the single batteries or battery cells and then discharges it into ambience. Such a system is, for example, disclosed by DE 10 2008 005 754 A1, wherein a device for cooling an energy store in a vehicle is described, with the HVAC system of the vehicle provided as a cooling device. The directly cooled air, which is led to the energy store, enables fast tempering to be obtained, and after having conditioned the battery, is removed into ambience.

In certain operational states of the vehicle, different requirements exist for the air conditioning of the passenger compartment and for the cooling of the battery. At low temperatures of the ambient air, conditioning the cooling air from a conventional HVAC system for cooling the battery during charging militates against a preheating of the passenger compartment of the vehicle by the HVAC system. Cooling the air for cooling the battery and heating the air for heating the passenger compartment cannot be performed simultaneously, as the cooling air can be conditioned to only one blowing temperature. When the HVAC system, for example, is operated in a “fully cold” mode while cooling is demanded, the air in a heating heat exchanger is not heated so that heat cannot be delivered to the passenger compartment. However, in electric vehicles, it is important to preheat the air for tempering the passenger compartment in order to reduce energy consumption during driving, thus increasing a distance range of the vehicle.

During charging, significant losses in charging power arise dependent upon the capacity of the battery, charging time, charging current or voltage, which can produce high waste heat flows (i.e. up to 25% of the power supplied) dependent upon the battery. The waste losses are dissipated during charging as heat via the heated cooling air from the battery casing and blown into ambience.

From EP 2 075 873 A1, a device is known for regulating the temperature of the battery of a vehicle with air directing elements, a cooling unit, a heating unit and return flow elements. The air directing elements are provided for taking air from the passenger compartment, wherein the air is coolable using the cooling unit, heatable using the heating unit, and then passed over the battery for cooling or heating. The return flow elements return the total or part of the air mass flow that has passed the battery into the passenger compartment. The other portion of the air mass flow is blown into the ambience of the vehicle. The system described in EP 2 075 873 A1 is placed in the rear of the vehicle and is provided with a plurality of additional components with additional heat exchangers and fans, which all require space and expensive control equipment. The air is drawn from the passenger compartment in the rear, also reentering the passenger compartment in the rear so that the returned air, particularly at little air mass flows, does not circulate through the entire passenger compartment, but only locally.

Also in DE 600 07 199 T2, an arrangement structure for a battery cooling duct of a vehicle is described. The battery cooling duct is provided with an additional fan for tempering the battery air drawn from the vehicle interior and supplied to the battery. Using air from the interior of the passenger compartment, which is conditioned before entering the passenger compartment and has a predefined restricted temperature range as opposed to when air from the ambience is used. However, using the air from the interior of the passenger compartment results in increased noise in the vehicle, thereby reducing comfort of the passengers. Moreover, the air from the interior of the passenger compartment will often have physical parameters that do not, or only insufficiently, cool the battery. Such physical parameters of the air mainly occur in the passenger compartment at hot temperatures such as in summer, for example.

It would be desirable to provide an HVAC system and a method for operating the HVAC system for a vehicle that is capable of conditioning the passenger compartment and enables tempering an energy store within a restricted temperature range. The tempering of the energy store is to be performed over an intermediate medium, with minimized number of additional components in the vehicle, thus minimizing a package size of the system. Also, the tempering of the energy store is to be performed at minimum energy effort, without additional effort for a control device and without any loss in comfort of the passengers. Therefore, the system is to be established at minimal cost and operated cost-effectively.

### SUMMARY OF THE INVENTION

An HVAC system according to the present invention is for use in a vehicle having a battery disposed within a battery casing. The HVAC system is provided with an air conditioning device of an air conditioning unit. The air conditioning device is placed in a front region of the vehicle for conditioning air for a passenger compartment of the vehicle. The air conditioning device is provided with an evaporator of a refrigerant circuit and a heating heat exchanger. The air conditioning device is further provided with an ambient air channel for drawing air from the vehicle ambience and a recirculating air channel for drawing air from the passenger compartment. According to the invention, the air conditioning device of the HVAC system is provided with a battery cooling channel as a flow connection between the air conditioning device and the battery casing.

The battery casing is provided with an outlet connected to an air distribution system. The air distribution system includes an outflow channel and a return channel so that the air can flow from the outlet of the battery casing through the outflow channel into the vehicle ambience or through the return channel into the passenger compartment. The return channel enters in the rear of the passenger compartment so that the battery outflow air enters in the rear of the passenger compartment, ensuring an efficient flow-through when the HVAC system is operated in recirculating mode.

Both the battery cooling channel, and the outflow and return channels each are provided with a flow control mechanism selectively positionable between an open position and a closed position. Dependent upon the position of the flow control mechanism in the outflow channel and the return channel, part of the air exiting the battery casing through the outlet can also be blown into the ambience, while the remainder enters into the passenger compartment. With the air entering through the return channel into the passenger compartment, the heat produced during charging of the battery is efficiently utilized to heat the passenger compartment. With returning the cooling air, which is provided for tempering the energy store within a restricted temperature range, into the passenger compartment the air mass flow serving to cool the battery fulfills another energetic function. That means that the air mass flow, first, is used to temper the battery and, second, to heat the passenger compartment. So it becomes advantageously possible to heat the interior of the passenger compartment without additional systems or energy to be needed while the vehicle is stationary. Tempering of both the battery and the passenger compartment is performed via air as the intermediate medium.

According to the invention, the battery cooling channel is placed at an outlet of the air conditioning device and switched in parallel to the cockpit outlets of the passenger compartment. Therefore, the battery cooling channel can be directly supplied with the conditioned air from the air conditioning device. The air flow passed through the battery cooling channel is directed to the battery casing and the battery disposed therein.

The battery, which is typically a plurality of battery cells, is arranged and fastened beneath the passenger compartment. Spaces are provided between the battery casing and the battery cells, and between each individual battery cell. The air, which is conditioned by the air conditioning device and passed through the battery cooling channel, flows through the spaces. Heat is transferred by convection between the air flowing through the spaces and the walls of the battery cells. Subsequently, the heated air flows through the outlet of the battery casing to the air distribution system, and either is released to the ambience and/or directed into the passenger compartment.

According to a further embodiment of the invention, the return channel is provided with a branch so that two sub-channels are established, each having a flow control mechanism selectively positionable between an open position and a closed position. A first sub-channel enters into the front region of the passenger compartment, whereas the second sub-channel ends in the rear region of the passenger compartment. The first sub-channel, ensuring the inflow of the heated battery outlet air into the front region of the passenger compartment, enables the complete passage of the passenger compartment when the HVAC system is operated in the ambient air mode. The heated battery outlet air flows from the front region of the passenger compartment in direction of the cabin exhaust ventilation, which is placed in the rear of the vehicle. The second sub-channel, which releases the heated battery outflow air into the rear region of the passenger compartment facilitates an efficient flow of the heated battery outlet or through the passenger compartment when the HVAC system is operated in the recirculating mode. Thus, heating the cabin even at low air rates.

The method according to the invention for operating the HVAC system includes passing conditioned air through the battery cooling channel into the battery casing, and within the battery casing the conditioned air flows around heat transferring surfaces of the battery cells. The air mass flow at the outlet of the battery casing, during an operation of the battery tempering, is directed, dependent upon the inside temperature of the passenger compartment and the ambient temperature of the vehicle, through the return channel of the air distribution system into the passenger compartment or into the ambience of the vehicle.

The air mass flow supplied into the passenger compartment is controlled by means of the flow control mechanisms placed within the return channel and the outflow channel. When the flow control mechanism in the return channel is opened, complete closure of the flow control mechanism in the outflow channel causes the entire air mass flow that is used for battery cooling to flow through the return channel into the passenger compartment. Conversely, when the flow control mechanism in the outflow channel is opened, complete closure of the flow control mechanism in the return channel causes the entire air mass flow to flow through the outflow channel into the ambience of the vehicle. The air mass flow, that exits through the outlet of the battery casing, is also dividable into two partial air mass flows so that a first partial air mass flow flows past the at least partially opened flow control mechanism of the return channel and through the return channel into the passenger compartment, while the second partial air mass flow flows past the at least partially opened flow control mechanism of the outflow channel and through the outflow channel into the ambience of the vehicle.

The positions of the flow control mechanisms in the outflow channel and the return channel are controlled dependent upon the inside temperature of the passenger compartment and the ambient temperature of the vehicle.

Due to the return channel being established with a branch and two partial channels each provided with a flow control mechanism selectively positionable between an open position and a closed position, with the first partial channel ending in the front region and the second partial channel ending in the rear region of the passenger compartment, an efficient optimal flow through of the outflow channel is advantageously released when operating the HVAC system in both the ambient air and the recirculating modes.

According to the invention, when the HVAC system is operated in the ambient air mode, ambient air from the ambience of the vehicle is drawn through the ambient air channel into the HVAC system. Then, dependent upon the demand, the ambient air is conditioned and directed through the battery cooling channel to the battery casing. The air mass flow, heated during the battery cooling process in the battery casing, is then supplied at least as partial mass flow through the front partial channel of the return channel into the passenger compartment. The heated air mass flow is caused to flow in direction of the cabin ventilation in the rear of the vehicle, so that complete flow-through of the passenger compartment is ensured. The heated air mass flow increases the temperature in the passenger compartment.

As a further embodiment of the invention, when the HVAC system is operated in the recirculating air mode, recirculating air from the passenger compartment is drawn through the recirculating air channel into the HVAC system and conditioned if necessary. Then, the recirculating air is supplied through the battery cooling channel to the battery casing. The air mass flow, heated during the battery cooling process in the battery casing, is supplied at least as partial mass flow through the rear partial channel of the return channel into the passenger compartment. The heated air mass flow is caused to flow in direction of the recirculating air channel of the air conditioning device placed in the front region of the vehicle. Accordingly, in the recirculating air mode, efficient flow-through and heating of the cabin is ensured. Such flow of the heated air mass flow ensures that the passenger compartment is heated even at low air flow rates.

Advantageously, the air to be conditioned for tempering the battery is drawn either through the ambient air channel from the ambience of the vehicle or through the recirculating air channel from the passenger compartment, and then directed to the evaporator of the HVAC system of the vehicle. Alternatively, it is possible to form the drawn air flow to be conditioned by mixing an air flow, that flows through the ambient air channel into the HVAC system, with an air flow, that flows through the recirculating air channel from the passenger compartment, and thereafter to lead the mixed flow to the evaporator of the HVAC system.

According to the invention, the air cooled and/or dehumidified when passing through the evaporator, can be led over the surfaces of a heating heat exchanger, and thereby heated. A partial air mass flow can bypass the heating heat exchanger by means of a temperature control mechanism, at the same time as a partial air mass flow is directed to the heating heat exchanger. Alternatively, the whole air mass flow can bypass the heating heat exchanger or be directed through the heating heat exchanger, if desired. Thus, the whole air mass flow is advantageously dividable at a ratio between zero and one.

The invention is advantageous as it: provides a simple battery cooling system, offering the possibility to precondition the passenger compartment, while it uses existing heat, thereby reducing the input power, or at minimum energy effort, and minimizes additional components in the vehicle, therefore saving space and being cost-effective, while ensuring maximum comfort.

Based on an arrangement of the air inlets into the passenger compartment, particularly the return channel, in both the operating mode of drawing recirculating air and the operating mode of drawing ambient air, efficient flow-through, and thereby heating, of the cabin even at low air flow rates is achieved.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic representation of a vehicle including an HVAC system according to an embodiment of the invention showing a battery cooling and a cooling air return for cabin heating; and

FIG. 2 is a schematic illustration of an air conditioning device including an additional connection for battery cooling.

### DETAILED DESCRIPTION OF EXEMPLARY EMBODIMENTS OF THE INVENTION

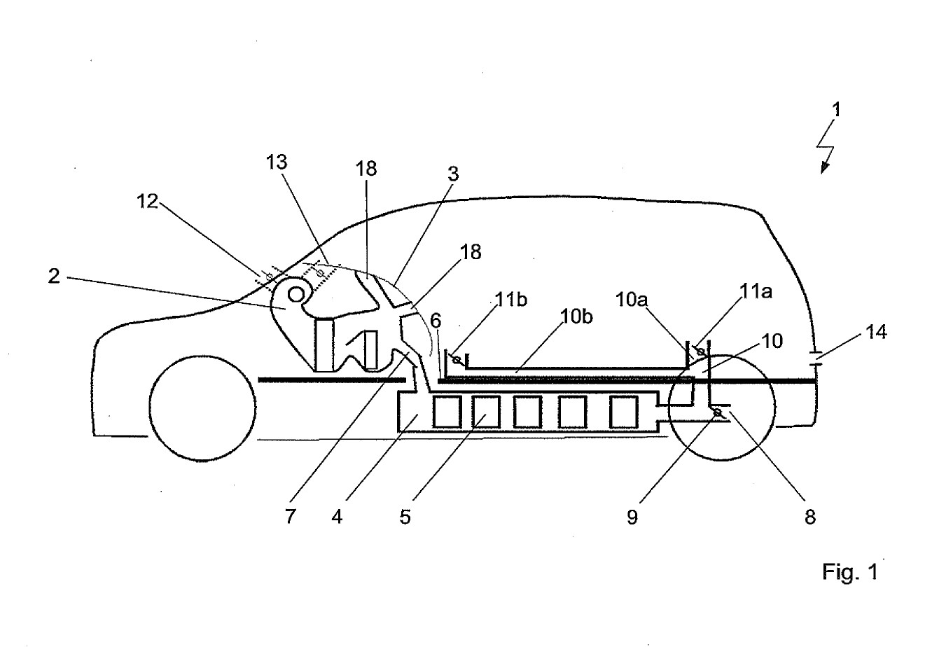

In FIG. 1 an HVAC system 1 for a vehicle with battery cooling and cooling air return for cabin heating is shown. The air conditioning device 2 is disposed in the cockpit 3, i.e. in the front region of the vehicle or the passenger compartment. In addition to cockpit outlets 18 in the front region, an ambient air channel 12, and a recirculating air channel 13, the air conditioning device 2 is provided with a battery cooling channel 7. So the HVAC system 1 is provided with a further outlet for battery cooling that turns into the battery cooling channel 7.

The battery, fastened beneath the cabin bottom 6, is established of several battery cells 5, with the battery cells 5 arranged integrated to a battery within the battery casing 4. Between the battery casing 4 and the battery cells 5 as well as the single battery cells 5 spaces are provided through which an air mass flow is passed. The air mass flow is conditioned dependent upon the desired temperature and operation of the battery cells 5. In this context, conditioning is essentially to be understood as tempering.

The battery cooling channel 7 creates a flow connection from the air conditioning device 2 to the battery casing 4 so that the conditioned air mass flow can be directed into the battery casing 4.

For cooling the air within the passenger compartment at high temperatures of the vehicle ambience, a partial flow of the air conditioned in the air conditioning device 2, i.e. cooled, by switching the cockpit outlets 18 and the battery cooling channel 7 in parallel is directed into the passenger compartment, and the other partial flow of the air to the battery casing 4. This ensures the cooling of both the battery and the air in the passenger compartment.

An air distribution system is located at the air outlet of the battery casing 4. The air distribution system makes possible to lead the outflow air of the battery cooling either through the outflow channel 8 into the ambience of the vehicle or through the return channel 10 into the passenger compartment so that the heat absorbed by the air flow when passing between and over the battery cells 5 during battery cooling is supplied into the passenger compartment. During operation of the battery cooling the outflow air, dependent upon the inside temperature of the passenger compartment and the ambient temperature of the vehicle, the air flow may be directed through the return channel 10 into the passenger compartment. This achieves a required cooling of the battery while supplying heat into the passenger compartment at the same time. Accordingly, the battery is coolable during, for example, charging while the air in the passenger compartment is preconditioned, or heated at the same time.

The return channel 10 is established with a branch and two partial channels 10a, 10b each provided with a flow control mechanism 11a, 11b selectively positionable between an open position and a closed position. The first partial channel 10b enters in the front region of the passenger compartment while the second partial channel 10a enters in the rear region of the passenger compartment.

The air mass flow and its division is controlled by a flow control mechanism within the outflow channel 8 and the flow control mechanisms 9, 11a, 11b within the return channel 10. By completely closing the flow control mechanism 9, the whole air mass flow used for battery cooling is passed through the return channel 10 into the passenger compartment. By contrast, by completely closing the flow control mechanisms 11a, 11b the whole air mass flow is passed through the outflow channel 8 into the ambience of the vehicle.

For exchanging the air within the passenger compartment with the air of the ambience, a cabin ventilation 14 such as an opening of the passenger compartment, for example, is provided in the rear region of the vehicle.

When operating the HVAC system 1 in an ambient air mode, ambient air from the ambience of the vehicle is drawn through the ambient air channel 12 into the HVAC system 1. After conditioning the drawn ambient air within the air conditioning device 2, the air flows through the battery cooling channel 7 to the battery casing 4. Inside the battery casing 4 the air absorbs heat when passing over the battery cells 5. The heated air mass flow is then, with both the flow control mechanism 9 of the outflow channel 8 and the flow control mechanism 11a of the rear partial channel 10a closed, passed through the front partial channel 10b of the return channel 10 into the passenger compartment. From the outlet of the front partial channel 10b, the heated air mass flow is mixed with the air in the passenger compartment and caused to flow in direction of the cabin ventilation 14 in the rear of the vehicle. In this way the heated air mass flow flows from the front region of the passenger compartment through the whole passenger compartment to the rear of the vehicle so that a complete passing-through of the passenger compartment is ensured.

Dependent upon the ambient conditions with regard to the vehicle, the HVAC system 1 can also be operated in a recirculating air mode. For that reason the power consumption of the refrigeration plant of the HVAC system 1, particularly in the evaporator region, is optimizable dependent upon the desired temperature levels.

When the HVAC system 1 is operated in the recirculating air mode, the air is drawn from the passenger compartment through the recirculating air channel 13 into the HVAC system 1. After conditioning the drawn air within the air conditioning device 2, the air flows through the battery cooling channel 7 to the battery casing 4. Like in the ambient air mode, the air absorbs heat within the battery casing 4 when passing over the battery cells 5. The heated air mass flow is then, with both the flow control mechanism 9 of the outflow channel 8 and the flow control mechanism 11b of the front partial channel 10b closed through the rear partial channel 10a of the return channel 10, supplied into the passenger compartment. From the outlet of the rear partial channel 10a, the heated air mass flow is mixed with the air in the passenger compartment and caused to flow in direction of the recirculating air channel 13 of the air conditioning device 2 placed in the front region of the vehicle. Because the recirculating air is drawn from the passenger compartment into the air conditioning device 2 in the region of the instrument panel, i.e. in the front region of the vehicle, the heated battery outflow air blown in the rear region of the passenger compartment flows through the passenger compartment and hence, scavenging and mixing of the air in the passenger compartment is achieved. In the recirculating air mode complete flow-through of the passenger compartment is possible.

The air is directed on different levels into and out of the passenger compartment in both the ambient air and recirculating air modes so that the heating action covers the whole passenger compartment. Optimal conditioning of the air in the passenger compartment is made possible by the advantageous flow-through at low air flow rates.

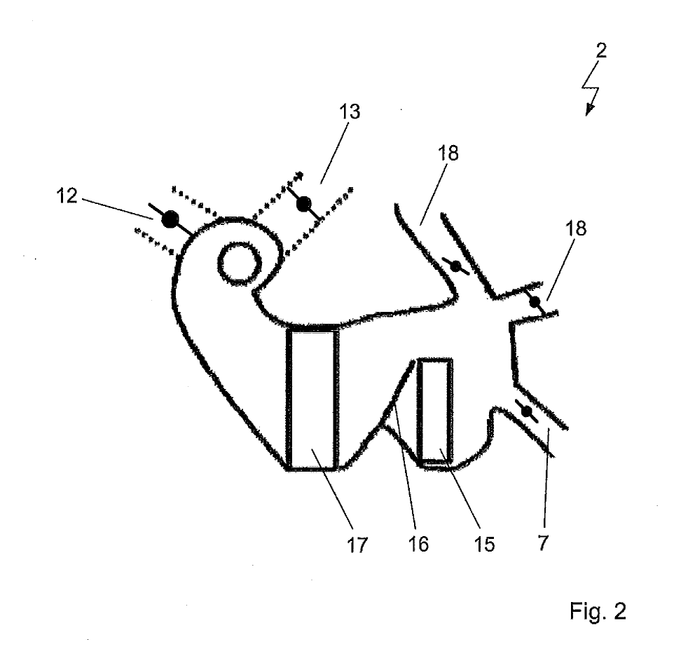

In FIG. 2 the air conditioning device 2 of the HVAC system 1 is shown with the additional port for the battery cooling, that is the port for the battery cooling channel 7. The battery cooling channel 7 can be closed by a flow control mechanism in the area of the transition to the casing of the air conditioning device 2.

The air to be conditioned by the HVAC system 1 is taken either through the ambient air channel 12 from the ambience of the vehicle or through the recirculating air channel 13 from the passenger compartment and passed to the evaporator 17 of the air conditioning unit of the vehicle. This is a vehicle air conditioning unit, which can be established and operated in various embodiments. The air that is cooled and/or dehumidified when passing over the heat transmitting surfaces of the evaporator 17 is dependent upon demand passed over the surfaces of the heating heat exchanger 15, and thereby heated. After having passed through the evaporator 17, the air mass flow bypasses the heating heat exchanger 15 by means of a temperature control mechanism 16, or at least a partial air mass flow is directed to the heating heat exchanger 15. Also, the whole air mass can flow through the surfaces of the heating heat exchanger 15 if desired.

After having been conditioned with help of the evaporator 17 and heating heat exchanger 15, the air mass flow is supplied to the cockpit outlets 18 and delivered into the passenger compartment in a conditioned state. The air mass flow is controlled with regard to the direction of flow by air mass over flow control mechanisms within the channels to the cockpit outlets 18.

In addition, it is also possible to direct a partial air mass flow or, dependent upon demand and setting, the whole conditioned air mass flow to the battery casing 4 through the battery cooling channel 7. The battery cooling channel 7, which is selectively opened and closed separate from the channels of the cockpit outlets 18 for battery cooling and tempering independent from a conditioning of the passenger compartment. The battery cooling channel 7 can be selectively opened and closed by means of a flow control mechanism, if desired. The battery cooling channel 7, as a flow connection from the air conditioning device 2 to the battery casing 4, passes the conditioned air mass flow into the battery casing 4. When the battery cooling is operated, the air mass flow leaving the battery casing 4 is warmer than the air mass flow entering at the inlet of the battery casing 4.

### NOMENCLATURE

1 HVAC system
2 air conditioning device
3 Cockpit
4 battery casing
5 battery cell
6 cabin bottom
7 battery cooling channel
8 outflow channel
9 flow control mechanism
10 return channel
10a rear partial channel
10b front partial channel
11a, 11b flow control mechanisms
12 ambient air channel
13 recirculating air channel
14 cabin ventilation
15 heating heat exchanger
16 temperature control mechanism
17 Evaporator
18 cockpit outlet

What is claimed is:

1. A heating, ventilating, and air-conditioning (HVAC) system for a vehicle, comprising:
a battery casing including a battery disposed therein;
an air conditioning device including a battery cooling channel and a plurality of outlets in fluid communication with a passenger compartment of the vehicle, wherein the battery cooling channel fluidly connects the air conditioning device and the battery casing; and
an air distribution system including an outflow channel and a return channel, the return channel fluidly connecting the battery casing and the passenger compartment of the vehicle, wherein the battery cooling channel and at least one of the outflow channel and the return channel cooperate to at least one of cool the battery and condition air in the passenger compartment.

2. The HVAC system according to claim 1, wherein the battery includes a plurality of battery cells.

3. The HVAC system according to claim 1, wherein the air conditioning device is disposed in a front region of the vehicle.

4. The HVAC system according to claim 1, wherein the air conditioning device further comprises an ambient air channel for receiving an air mass flow from an ambience of the vehicle and a recirculating air channel for receiving an air mass flow from the passenger compartment of the vehicle.

5. The HVAC system according to claim 1, wherein one of the outlets of the air conditioning device is fluidly connected to the battery cooling channel and is selectively opened and closed separately from the outlets of the air conditioning device in fluid communication with the passenger compartment to permit a cooling of the battery independent from a conditioning of the passenger compartment.

6. The HVAC system according to claim 1, wherein the outflow channel of the air distribution system is in fluid communication with an ambience of the vehicle.

7. The HVAC system according to claim 1, wherein at least one of the battery cooling channel, the outflow channel, and the return channel includes a flow control mechanism disposed therein to selectively open and close the at least one of the battery cooling channel, the outflow channel, and the return channel.

8. The HVAC system according to claim 1, wherein the return channel includes a first sub-channel and a second sub-channel, the first sub-channel in fluid communication with a rear region of the passenger compartment and the second sub-channel in fluid communication with a front region of the passenger compartment.

9. The HVAC system according to claim 8, wherein the second sub-channel is closed when the air conditioning device is operating in a recirculating air mode.

10. The HVAC system according to claim 8, wherein the first sub-channel is closed when the air conditioning device is operating in an ambient air mode.

11. A method for operating an HVAC system of a vehicle, comprising the steps of:
providing a battery casing including a battery disposed therein;
providing an air conditioning device including a battery cooling channel and a plurality of outlets in fluid communication with a passenger compartment of the vehicle, wherein the battery cooling channel fluidly connects the air conditioning device and the battery casing;
providing an air distribution system including an outflow channel and a return channel, the outflow channel fluidly connecting the battery casing to an ambience of the vehicle and the return channel fluidly connecting the battery casing and the passenger compartment of the vehicle; and
directing an air mass flow into at least one of the passenger compartment and the battery casing to maintain a desired temperature within the passenger compartment and a desired temperature of the battery disposed in the battery casing.

12. The method according to claim 11, wherein the return channel includes a first sub-channel and a second sub-channel, the first sub-channel in fluid communication with a rear region of the passenger compartment and the second sub-channel in fluid communication with a front region of the passenger compartment.

13. The method according to claim 12, further comprising the step of directing at least a portion of the air mass flow from the battery casing through the first sub-channel of the air distribution system when the air conditioning device is operating in a recirculating air mode.

14. The method according to claim 12, further comprising the step of directing at least a portion of the air mass flow from the battery casing through the second sub-channel of the air distribution system when the air conditioning device is operating in an ambient air mode.

15. The method according to claim 12, wherein at least one of the battery cooling channel, the outflow channel, the first sub-channel, and the second sub-channel includes a flow control mechanism disposed therein to selectively open and close the at least one of the battery cooling channel, the outflow channel, the first sub-channel, and the second sub-channel.

16. The method according to claim 11, further comprising the step of directing at least a portion of the air mass flow from the battery casing through the outflow channel to the ambience of the vehicle.

17. The method according to claim 11, wherein the air conditioning device further comprises an ambient air channel for receiving air from the ambience of the vehicle and a recirculating air channel for receiving air from the passenger compartment of the vehicle.

18. The method according to claim 11, further comprising the step of directing the air mass flow received into the air conditioning device, wherein at least a portion of the air mass flow is caused to one of bypass a heat exchanger disposed in the air conditioning device and flow through the heat exchanger disposed in the air conditioning device.

19. A method for operating an HVAC system of a vehicle, comprising the steps of:
providing a battery casing including a battery disposed therein;
providing an air conditioning device including an ambient air channel for receiving an air mass flow from an ambience of the vehicle, a recirculating air channel for receiving an air mass flow from a passenger compartment of the vehicle, an evaporator for conditioning the air mass flow received in the air conditioning device, and a battery cooling channel, wherein the battery cooling channel fluidly connects the air conditioning device and the battery casing;
providing an air distribution system including an outflow channel and a return channel, the outflow channel fluidly connecting the battery casing to an ambience of the vehicle, and the return channel includes a first sub-channel and a second sub-channel, wherein the first sub-channel is in fluid communication with a rear region of the passenger compartment and the second sub-channel is in fluid communication with a front region of the passenger compartment;
directing at least a portion of the conditioned air mass flow through the battery cooling channel into the battery casing to maintain a desired temperature of the battery;
directing at least a portion of the heated air mass flow from the battery casing through the first sub-channel of the air distribution system to maintain a desired temperature within the passenger compartment when the air conditioning device is operating in a recirculating air mode;
directing at least a portion of the heated air mass flow from the battery casing through the second sub-channel of the air distribution system to maintain the desired temperature within the passenger compartment when the air conditioning device is operating in an ambient air mode;

20. The method according to claim 19, further comprising the step of directing at least a portion of the heated air mass flow from the battery casing through the outflow channel to maintain the desired temperature in the passenger compartment.
